(19) United States
(12) Patent Application Publication
(10) Pub. No.: US 2024/0290532 A1
(43) Pub. Date: Aug. 29, 2024

(54) COIL COMPONENT

(71) Applicant: TDK Corporation, Tokyo (JP)

(72) Inventors: Yuichi OYANAGI, Tokyo (JP); Toru Tonogai, Tokyo (JP); Tomoya Ishihara, Tokyo (JP)

(73) Assignee: TDK Corporation, Tokyo (JP)

(21) Appl. No.: 18/585,359

(22) Filed: Feb. 23, 2024

(30) Foreign Application Priority Data
Feb. 27, 2023 (JP) 2023-028882

(51) Int. Cl. H01F 27/255; H01F 17/04; H01F 27/28

(52) U.S. Cl. CPC H01F 27/255; H01F 17/04; H01F 27/2823

(57) ABSTRACT

In a coil component, a recess provided on a surface of a magnetic sheet contributes to an enlargement of a bonding area between an element body and a magnetic sheet, and thus the interfacial peeling between the element body and the magnetic sheet is suppressed. In particular, since the magnetic sheet covers the entire region of the element body when viewed from the direction of the coil axis, the bonding area may be maximized and interfacial peeling may be further suppressed.

### CROSS-REFERENCE TO RELATED APPLICATIONS

This application is based upon and claims the benefit of priority from Japanese Patent Application No. 2023-28882, filed on 27 Feb. 2023, the entire content of which is incorporated herein by reference.

### TECHNICAL FIELD

The present disclosure relates to a coil component.

### BACKGROUND

Japanese Patent Application Publication No. 2003-203813 discloses a coil component including an insulating element body having a coil and a sheet-like magnetic body disposed on the element body.

### SUMMARY

The inventors have studied the leakage flux of the coil component that causes noise, and have found that the leakage flux can be reduced by providing a magnetic sheet inside a magnetic element body including the coil. In this case, if the bonding between the magnetic element body and the magnetic sheet is not sufficient, interfacial peeling between the magnetic element body and the magnetic sheet may occur.

According to various aspects of the present disclosure, there is provided a coil component in which interfacial peeling between an element body and a magnetic sheet is suppressed.

A coil component according to one aspect of the present disclosure includes an element body made of material including metal powder and resin, a coil provided in the element body, and a magnetic sheet extending in the element body, intersecting an axis of the coil, and having a recess in a part of a surface of the magnet sheet.

In the coil component, interfacial peeling between the element body and the magnetic sheet is suppressed by the recess of the magnetic sheet.

### BRIEF DESCRIPTION OF THE DRAWINGS

FIG. 1 shows a schematic perspective view of a coil component according to one embodiment.

FIG. 2 shows a cross-sectional surface view taken along line II-II of the coil component shown in FIG. 1.

FIG. 3 shows a schematic perspective view of the coil shown in FIG. 2.

FIG. 4 shows an enlarged cross-sectional view of a main part of an interface between the element body and the magnetic sheet.

FIG. 5 shows a cross-sectional surface view of a coil component different from that shown in FIG. 2.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

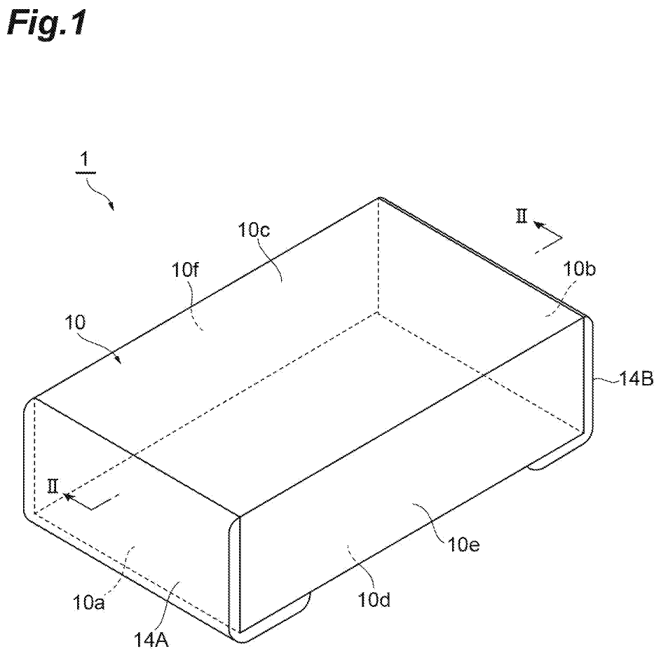

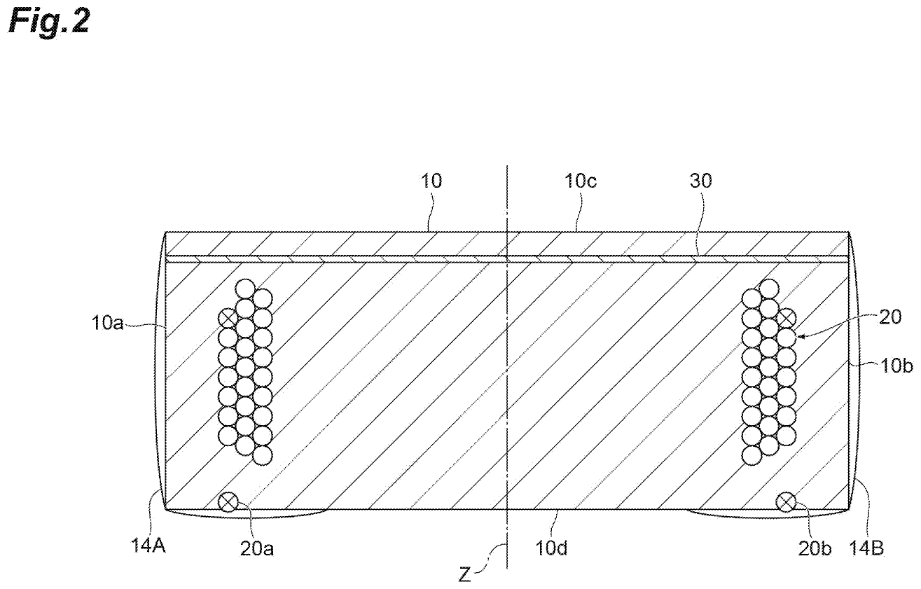

As shown in FIGS. 1 and 2, a coil component 1 according to one embodiment includes an element body 10, a coil 20 embedded in the element body 10, and a pair of external terminals 14A and 14B provided on the surface of the element body 10.

The element body 10 has a substantially rectangular parallelepiped outer shape and includes six surfaces 10a to 10f. The element body 10, as an example, is designed with dimensions of a longer side 2.5 mm, a shorter side 2.0 mm, height 1.2 mm. Of the surfaces 10a to 10f of the element body 10, end surfaces 10a and 10b are parallel to each other, an upper surface 10c and a lower surface 10d are parallel to each other, and side surfaces 10e and 10f are parallel to each other. The lower surface 10d of the element body 10 is the surface parallel and facing to the mounting surface of the mounting substrate on which the coil component 1 is mounted.

The element body 10 is made of metal magnetic powder-containing resin, which is one kind of magnetic material. The metal magnetic powder-containing resin is a bound powder in which metal magnetic powder is bound by binder resin. The metal magnetic powder of the metal magnetic powder-containing resin contains, for example, iron, and is composed of alloy-based material such as permalloy, sendust, FeSiCr, FeSi, carbonyl iron, amorphous alloy, nanocrystal, or the like. The metal magnetic powder may be selected from materials having hardness higher than that of the magnetic sheet 30, which will be described later. The binder resin is, for example, a thermosetting epoxy resin. In the present embodiment, the content of the metal magnetic powder in the bound powder is 75 to 92 vol % in volume percent, and 95 to 99 wt % in weight percent. From the viewpoint of the magnetic property, the content of the metal magnetic powder in the bound powder may be 80 to 92 vol % in volume percent and 97 to 99 wt % in weight percent.

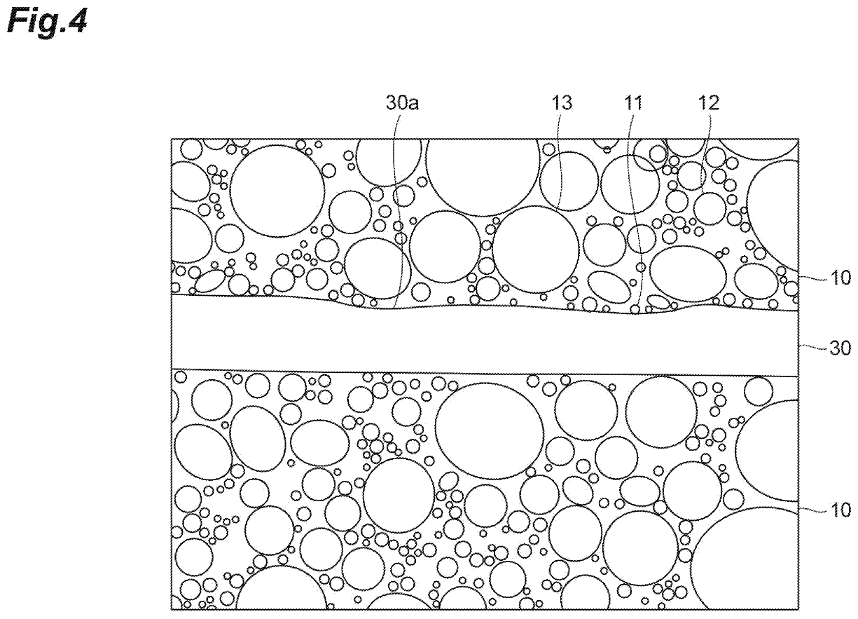

The magnetic powder of the metal magnetic powder-containing resin constituting the element body 10 may be a powder having one kind of average particle diameter or a mixed powder having a plurality of kinds of average particle diameters. When the magnetic powder of the metal magnetic powder-containing resin constituting the element body 10 is a mixed powder, the types of magnetic powders having different average particle diameters and the Fe composition rate may be the same or different. In the present embodiment, the metal magnetic powder-containing resin constituting the element body 10 includes mixed powder having three types of average particle diameters. As an example, particles having the maximum average particle diameter (maximum diameter powder 14 in FIG. 4) have 15 to 30 μm diameter, particles having the minimum average particle diameter (minimum diameter powder 11 in FIG. 4) have 0.3 to 1.5 μm diameter, and particles having diameters between the maximum and the minimum diameters (medium diameter powder 12 in FIG. 4) have 3 to 10 μm diameter. Relative to 100 parts by weight of the mixed powder, the maximum diameter powder 14 may be contained in a range of 60 to 80 parts by weight, the medium diameter powder 12 may be contained in a range of 10 to 20 parts by weight, and the minimum diameter powder 11 may be contained in a range of 10 to 20 parts by weight.

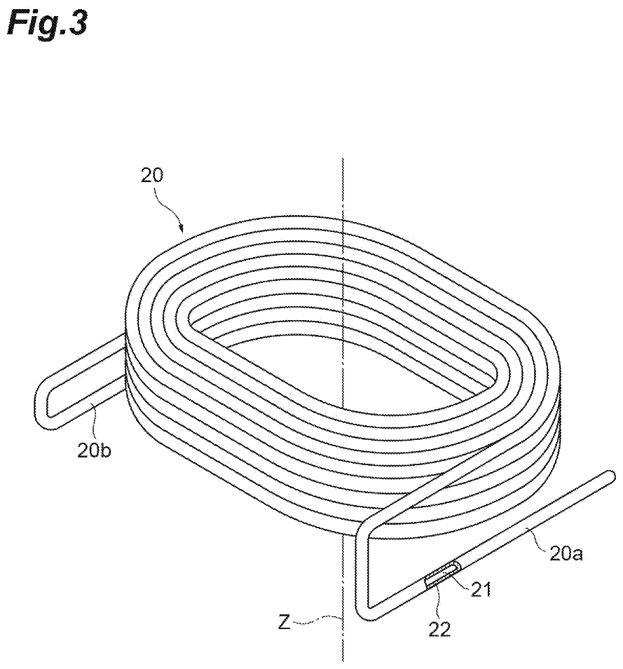

The coil 20 is embedded in the element body 10. As shown in FIG. 3, the coil 20 is formed of a wire-like coated conductive wire. The wire may be obtained by coating a core material 21 made of Cu or the like with an insulating coating 22 (insulator). The coil 20 has an axis Z extending in the vertical direction (i.e., the facing direction of the upper surface 10c and the lower surface 10d). In the present embodiment, one coil conductor is spirally wound in multiple layers along the vertical direction, and more specifically, spirally wound triply. One end portion 20a and the other end portion 20b of the coil 20 are exposed to the lower surface 10d in the element body 10. In the present embodiment, the end portions 20a and 20b of the coil 20 extend in a direction parallel to the end surfaces 10a and 10b in the lower surface 10d in the element body 10. In both of the end portions 20a and 20b of the coil 20, the insulating coating 22 is removed by polishing or the like, and the core material 21 is exposed at the lower surface 10d. The end portions 20a and 20b of the coil 20 are connected to portions covering the lower surface 10d of the element body 10 of the external terminals 14A and 14B, respectively. The coil 20 may be a round wire having a circular cross-sectional surface or a rectangular wire having a quadrangular cross-sectional surface.

Both the external terminals 14A and 14B are bent in an L-shape and continuously cover the end surfaces 10a and 10b and the lower surface 10d. The external terminal 14A covers entire the end surface 10a and a partial region of the lower surface 10d (in particular, a rectangular region extending along the edge on the end surface 10a side). The external terminal 14B covers entire the end surface 10b and a partial region of the lower surface 10d (in particular, a rectangular region extending along the edge on the end surface 10b side). Portions covering the lower surface 10d of the external terminals 14A and 14B cover the end portions 20a and 20b of the coil 20 exposed to the lower surface 10d.

In the present embodiment, the external terminals 14A and 14B are formed of resin electrodes, for example, Ag powder-containing resin. The external terminals 14A and 14B can be formed by metal plating. The external terminals 14A and 14B may have a single-layer structure or a multilayer structure. The external terminals 14A and 14B may directly cover the surface of the element body 10, or may indirectly cover the surface of the element body 10 through a predetermined insulation layer. For example, the insulation layer may be provided over the entire formation region of the external terminals 14A and 14B excluding the connection region between the end portions 20a and 20b of the coil 20 and the external terminals 14A and 14B. The insulation layer may be made of epoxy resin or the like.

The magnetic sheet 30 is further provided inside the element body 10. The magnetic sheet 30 extends to intersect the axis Z of the coil 20. In the present embodiment, the magnetic sheet 30 extends perpendicular to the axis Z of the coil 20. The magnetic sheet 30 extends over the entire region of the element body 10 when viewed from the direction of the axis Z of the coil 20. That is, when viewed from the direction of the axis Z of the coil 20, the element body 10 has a rectangular shape, and the magnetic sheet 30 also has a rectangular shape having substantially the same dimensions as the element body 10. The magnetic sheet 30 may be in the form of a complete sheet or a locally divided sheet as long as it covers the entire region of the element body 10 when viewed from the direction of the axis Z of the coil 20.

In the present embodiment, the magnetic sheet 30 is located above the coil 20. That is, the magnetic sheet 30 is located between the coil 20 and the upper surface 10c of the element body 10 with respect to the vertical direction of the element body 10 (i.e., the direction of the axis Z of the coil 20). In the present embodiment, the magnetic sheet 30 is not exposed from the upper surface 10c of the element body 10 and is not in contact with the coil 20.

The magnetic sheet 30 may be formed of metal plate (or metal ribbon). The magnetic sheet 30 may be formed of amorphous ribbon or nanocrystalline ribbon. The magnetic sheet 30 may be made of composite material including metal magnetic powder and resin. The magnetic sheet 30 may be a single-layer structure made of one kind of material or a multilayer structure composed of one kind or multiple kinds of materials. When the magnetic sheet 30 has a multilayer structure, the magnetic sheet 30 may include a layer made of non-magnetic material (for example, a resin layer) in addition to a layer made of magnetic material (magnetic layer).

As shown in FIG. 4, the magnetic sheet 30 has a recess 30a on a portion of the surface of the magnetic sheet 30. The recess 30a may be on only one surface or on both surfaces of the magnetic sheet 30. Further, the number of the recess 30a may be one or more. The recess 30a of the magnetic sheet 30 is taken into the metal magnetic powder-containing resin constituting the element body 10, and the recess 30a is filled with the metal magnetic powder-containing resin. As shown in FIG. 4, the minimum diameter powder 11 of three kinds of the magnetic powders 11 12 and 13 in the metal magnetic powder-containing resin is taken into the recess 30a, and binder resin constituting the metal magnetic powder-containing resin is also taken into the recess 30a.

In the coil component 1 described above, the recess 30a provided on the surface of the magnetic sheet 30 contributes to enlargement of the bonding area between the element body 10 and the magnetic sheet 30, thereby suppressing interfacial peeling between the element body 10 and the magnetic sheet 30. In particular, when viewed from the direction of the axis Z of the coil 20, the magnetic sheet 30 extends over the entire region of the element body 10, thereby maximizing the bonding area and further suppressing interfacial peeling.

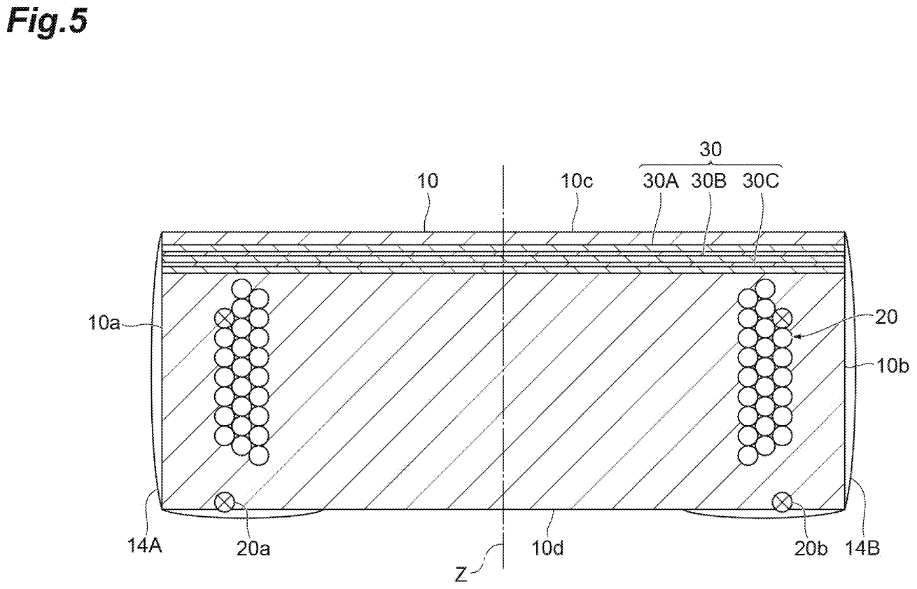

Only one magnetic sheet 30 may be provided in the element body 10, or a plurality of the magnetic sheets 30 may be provided in the element body 10. FIG. 5 shows an embodiment in which three magnetic sheets 30 (magnetic sheets 30A, 30B, and 30C) are provided. The three magnetic sheets 30A, 30B and 30C extend to intersect the axis Z of the coil 20 (extend perpendicular to the axis Z of the coil 20 in FIG. 5). The magnetic sheets 30A, 30B, and 30C extend over the entire region of the element body 10 when viewed from the direction of the axis Z of the coil 20. All or part of the magnetic sheets 30A, 30B, and 30C may be in the form of a complete sheet or a locally divided sheet as long as it extends over the entire region of the element body 10 when viewed from the direction of the axis Z of the coil 20.

All of the magnetic sheets 30A, 30B, and 30C are located on the upper side of the coil 20. That is, all of the magnetic sheets 30A, 30B, and 30C are located between the coil 20 and the upper surface 10c of the element body 10 in the vertical direction of the element body 10. In the present embodiment, none of the magnetic sheets 30A, 30B, and 30C are exposed from the upper surface 10c of the element body 10 and none of the magnetic sheets 30A, 30B, and 30C are in contact with the coil 20.

The metal magnetic powder-containing resin constituting the element body 10 is interposed between the layers of the magnetic sheets 30A, 30B, and 30C. The interlayer distance of the magnetic sheets 30A, 30B, and 30C may be equal or different.

The magnetic sheets 30A, 30B, and 30C may be a single-layer structure constituted by one kind of material, or may be a multilayer structure constituted by one kind material or a plurality of kinds of materials, similarly to the magnetic sheet 30 described above. When the magnetic sheets 30A, 30B, and 30C have a multilayer structure, the magnetic sheets 30A, 30B, and 30C may include a layer made of non-magnetic material (for example, a resin layer) in addition to a layer made of magnetic material (magnetic layer).

Also in the embodiment shown in FIG. 5, the recess 30a provided on all or part of the surfaces of the magnetic sheets 30A, 30B, and 30C contributes to enlargement of the bonding area between the element body 10 and the magnetic sheets 30A, 30B, and 30C, thereby suppressing interfacial peeling between the element body 10 and the magnetic sheets 30A, 30B, and 30C. In particular, when the magnetic sheets 30A, 30B, and 30C are viewed from the direction of the axis Z of the coil 20, the bonding area is maximized over the entire region of the element body 10, and interfacial peeling can be further suppressed.

The present disclosure is not necessarily limited to the above-described embodiments, and various modifications can be made without departing from the scope of the present disclosure. For example, the shape of the coil in plain view is not limited to elliptical annular or rectangular annular, and may be annular or polygonal annular.

What is claimed is:

1. A coil component comprising:
an element body made of material including metal powder and resin;
a coil provided in the element body; and
a magnetic sheet extending in the element body, intersecting an axis of the coil, and having a recess in a part of a surface of the magnet sheet.

2. The coil component according to claim 1, wherein the magnetic sheet is formed of a metal plate.

3. The coil component according to claim 1, wherein hardness of the metal powder is higher than hardness of the magnetic sheet.

4. The coil component according to claim 1 comprising a plurality of layers of the magnetic sheets in the element body.

5. The coil component according to claim 4, wherein material of the element body is interposed between adjacent layers of the magnetic sheets.

6. The coil component according to claim 1, wherein material of the element body includes a plurality of types of metal powders having different average particle diameters, and the metal powder having a smaller average particle diameter and the resin are taken into the recess of the magnetic sheet.

7. The coil component according to claim 1, wherein the magnetic sheet extends over an entire region of the element body when viewed from a direction of the axis of the coil.
